(19) United States
(12) Patent Application Publication
(10) Pub. No.: US 2015/0323692 A1
(43) Pub. Date: Nov. 12, 2015

(54) SEISMIC CABLE AND MODULAR SEISMIC SYSTEM

(71) Applicant: SeaBird Exploration Norway AS, Oslo (NO)

(72) Inventor: Dag W. REYNOLDS, Nesoddtangen (NO)

(21) Appl. No.: 14/410,348

(22) PCT Filed: Jun. 19, 2013
(86) PCT No.: PCT/EP2013/062753

§ 371 Date: Dec. 22, 2014

(30) Foreign Application Priority Data
Jun. 20, 2012 (NO) 20120716

(51) Int. Cl. G01V 1/38; G01V 1/137; G01V 1/20

(52) U.S. Cl. CPC G01V 1/3808; G01V 1/3826; G01V 1/201; G01V 1/137

(57) ABSTRACT

A method for seismic surveying includes positioning a first vessel equipped with first air gun and a first towline at a first selected position and positioning a second vessel equipped with a second air gun and a second towline at a second selected position. The method also includes attaching a transverse tow wire having a paravane fastened at each end to the first towline and the second towline, attaching a streamer cable to the transverse tow wire, and firing at least one of the first air gun and the second air gun and receiving seismic data using the streamer cable.

### INTRODUCTION

The present invention relates to a seismic streamer cable for marine seismic surveying. More specifically, described herein is a seismic cable in a modular seismic system including at least one such cable and a method for seismic surveying using the seismic cable.

### BACKGROUND OF THE INVENTION

Seismic surveys and equipment used therefore are well known for mapping properties of the bedrock where such surveys are carried out.

In marine environments different arrangements are known including one or more vessels that tow one or more streamer cables behind them.

Conventional seismics, however, is inflexible and calls for large vessels to tow many cables. The vessels used are primarily ships built solely for seismology, which have very few prospects for other work when there is an overcapacity in the market. In addition, conventional seismics requires that the cables be separated very close to the stern of the vessel. This is done by means of doors and requires a great deal of energy. The result is high operating costs and substantial environmental emissions.

The present invention avoids these problems by means of a modular seismic system comprising streamer cables that are an independent unit comprising all means for receiving and transmitting seismic data. The system can be adapted to specific purposes and does not require large specialised vessels.

### BRIEF DESCRIPTION OF THE INVENTION

The present invention relates to a seismic streamer cable for marine seismic surveying, the cable being characterised in that it comprises a forward end provided with a buoy and a rear end provided with a tail buoy, wherein at least one of the buoys comprises means for receiving and transmitting seismic data from hydrophones in the seismic cable.

Additional features of the seismic cable are described in the set of claims.

The invention is further described by a modular seismic system for marine seismic surveying, the system comprising a vessel equipped with an air gun and a towline, and a streamer cable having a forward end provided with a buoy and a rear end provided with a tail buoy, and wherein at least one of the buoys comprises means for receiving and transmitting seismic data from hydrophones in the seismic cable.

Additional features of the modular seismic system are described in the set of claims.

The invention also comprises a method for seismic surveying, the method comprising positioning at least one vessel equipped with an air gun and a towline at a selected position, attaching at least one streamer cable to said towline, the streamer cable having a forward end provided with a buoy and a rear end provided with a tail buoy, wherein at least one of the buoys comprises means for receiving and transmitting seismic data from hydrophones in the seismic cable, and firing the air gun and receiving seismic data via said streamer cable.

Additional features of the method are described in the set of claims.

### DETAILED DESCRIPTION OF THE INVENTION

The invention will now be described in more detail with reference to figures, wherein:

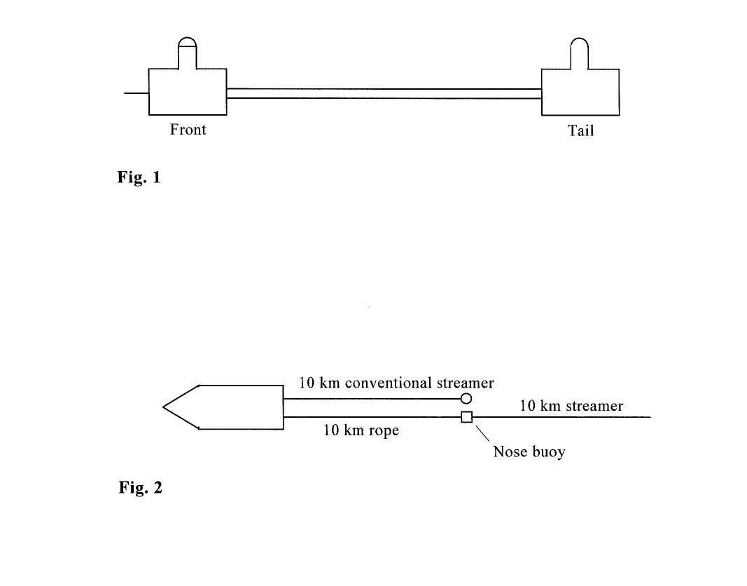

FIG. 1 shows a streamer cable according to the invention;

FIG. 2 shows an example of a modular seismic system including said streamer cable, and

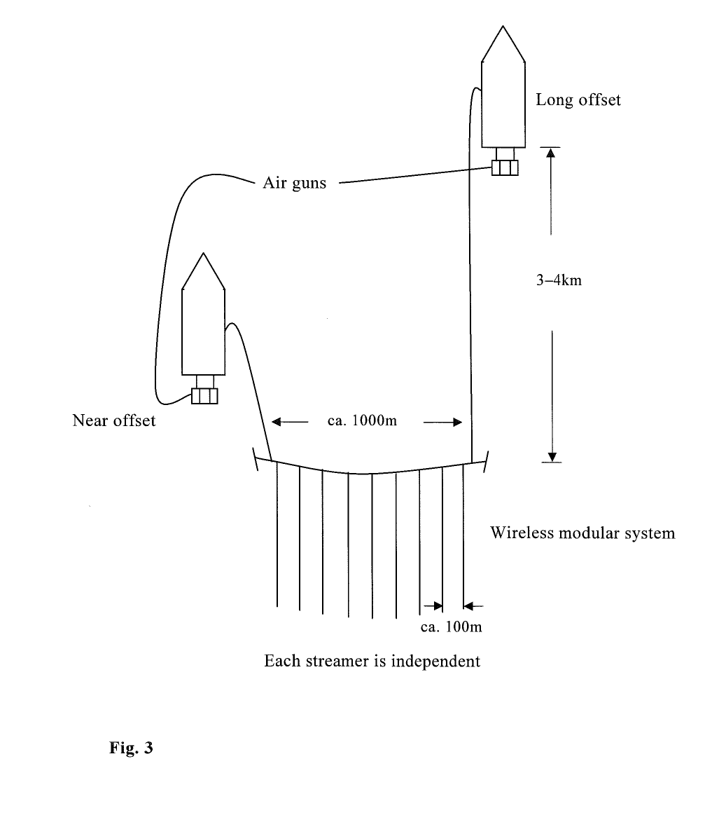

FIG. 3 shows another example of a modular seismic system including the streamer cable.

FIG. 1 shows a streamer cable according to the invention. The figure shows a streamer cable for marine seismic surveying.

The streamer cable has a buoy at each end. One of these buoys comprises means for receiving and transmitting seismic data from hydrophones to a vessel by radio telemetry, the hydrophones being, in a known way, incorporated in the seismic cable. By incorporating receiver means into one of the buoys and signal-connecting them to a plurality of hydrophones in the seismic cable, seismic data can be coordinated, logged and/or transmitted to a receiving unit. Real-time data can be received by immediate transmission of generated seismic data. Alternatively, such data can be stored for later review.

In an embodiment of the streamer cable, one or both buoys comprise a power generator.

The streamer cable will in that case be autonomous and will itself comprise all means necessary for receiving and transmitting seismic data. Seismic data is preferably transmitted wirelessly.

In that one or both of the buoys at respective forward and rear ends of the streamer cables comprise a power generator, the streamer cables will be self-sufficient in power such that they can receive and relay seismic data.

The power generator may be driven by a rotating device that rotates owing to propulsion in the water, as well as by batteries to assure regularity. The rotating device may be a bar connected to a propeller-like device that rotates upon propulsion in the water. Solar panels may also be incorporated as a part of the power generator in order to supply power and/or charge said batteries.

In another embodiment, the streamer cable receives its power supply through a conductor from a vessel.

The forward buoy may further comprise GPS for position determination. Position data will then be transmitted together with seismic data to a receiver, e.g., on a vessel, for further processing.

In one embodiment, the forward end may have propulsion means consisting of a small vessel, which may be unmanned. This vessel may be connected to attachment means in the forward buoy in order to provide propulsion in the water.

In another embodiment, the forward buoy itself may comprise propulsion means, such as e.g., an electromotor or the like, which generates energy and which is in connection with a device that provides propulsion in the water, e.g., a propeller or a jet-stream generating means.

At the rear end of the streamer cable is a tail buoy. The rear buoy may also comprise GPS for position determination. With GPS incorporated in both the forward and rear buoy, the direction of the streamer cable will be determinable. Position data from the rear buoy can be transferred via the seismic cable to the forward buoy that has receiver means therefore as well as transmitter means for transmitting data on to a receiving unit.

FIG. 2 shows an example of a modular seismic system including the streamer cable. The system comprises a vessel equipped with an air gun and a towline, and a streamer cable having a forward end provided with a buoy connected to said towline. The streamer cable also has a rear end provided with a tail buoy, and at least one of the said buoys comprises means for receiving and transmitting seismic data from hydrophones in the seismic cable.

The system is modular in the sense that one or more streamer cables can be secured to one or more towlines as required.

In the example in FIG. 2, an outline is shown of a towing solution for 20 km of 2D seismic surveying. The maximum length for conventional cables is 12-13 km. The use of a standard seismic cable secured to a vessel, and a streamer cable according to the invention that is secured to a line, which, in turn, is secured to the vessel, will result in a very flexible system that will cover large areas during a seismic survey.

FIG. 3 shows another example of a modular seismic system including the streamer cable. In addition to what is incorporated in the system described in FIG. 2, the extended system further comprises one vessel equipped with an air gun and a towline, and a transverse tow wire with a paravane fastened to each end, which is further attached to said towlines from said vessels.

In an embodiment, the modular system comprises a plurality of streamer cables with forward ends connected to said towline via forward buoys, and rear ends provided with tail buoys, wherein at least one of the buoys on each streamer cable comprises means for receiving and transmitting seismic data from hydrophones in the seismic cables.

In a preferred embodiment, the vessels are arranged in an asymmetric towing configuration in which one of the vessels tows close to the forward buoy or buoys of the seismic streamer cables in order to acquire near-offset data, whilst the other tows further forward in order to acquire long-offset data.

Examples of distances are that the one vessel that is closest to the streamer cables and which, with its air gun, shoots short offset is around 200-1000 m ahead of the cables, whilst the vessel that shoots long offset is about 2000-6000 m ahead of them.

This is envisaged with the close boat 200-1000 m ahead of the cables, whilst the boat that shoots long offset data is 2000-6000 m ahead of the cables. Cable length will then be 1000-3000 m per cable.

The present invention is also characterised by a method for seismic surveying that comprises positioning at least one vessel equipped with an air gun and a towline at a selected position. Furthermore, there is attached at least one streamer cable having a forward end connected to said towline via a forward buoy and a rear end provided with a tail buoy, at least one of the buoys comprising means for receiving and transmitting seismic data from hydrophones in the seismic cable. Lastly, the air gun is fired and seismic data can be received via said streamer cable.

Use of only one streamer cable describes a method for 2D seismic surveying. The use of two or more seismic cables allows 3D seismic surveying to be carried out.

A method for carrying out the invention covers both long and short offset from air guns to streamer cables. This permits seismic surveys in areas where there is both deep and shallow water. The method is then characterised by positioning an additional vessel equipped with an air gun and a towline in a selected position, and then attaching a transverse tow wire with a paravane fastened at each end, which is further fastened to said towlines from said vessels as shown in FIG. 3. Lastly, the air guns are fired from each vessel and seismic data can be received via said streamer cable.

By attaching a plurality of said streamer cables to said tow wire and positioning the boats at a given distance from one another, there will be obtained an asymmetric towing configuration in which one of the boats tows close to the forward buoy or buoys in order to acquire near-offset data, whilst the other tows further forward in order to acquire long-offset data.

The present invention will be capable of providing a highly flexible arrangement for both 2D and 3D seismic surveys and giving high density and wide azimuth of seismic data. It will cover surveys in both deep and shallow water and not least be highly flexible in order to meet needs adapted to different geological conditions and can easily be adapted to different ocean areas. Furthermore, the system is cost-efficient compared with existing systems.

1. A seismic streamer cable for marine seismic surveying, the cable being characterised in that it comprises a forward end provided with a buoy and a rear end provided with a tail buoy, wherein at least one of the buoys comprises means for receiving and transmitting seismic data from hydrophones in the seismic cable.

2. A seismic streamer cable according to claim 1, characterised in that one or both of the buoys further comprise GPS.

3. A seismic streamer cable according to claim 1, characterised in that it receives power supply in that it itself generates power, this being made possible in that one or both buoys comprise a power generator that is driven by a rotating device which rotates owing to propulsion in the water, and also batteries to assure regularity.

4. A seismic streamer cable according to claim 1, characterised in that it receives power supply through an electric conductor from a vessel.

5. A seismic streamer cable according to claim 1, characterised in that the buoy at the forward end has propulsion means consisting of a small vessel, which may be unmanned.

6. A seismic streamer cable according to claim 1, characterised in that the forward buoy has attachment means for connection to means that provide propulsion in the water.

7. A modular seismic system for marine seismic surveying characterised in that it comprises:
a vessel equipped with an air gun and a towline; and
a streamer cable having a forward end provided with a buoy and a rear end provided with a tail buoy, wherein at least one of the buoys comprises means for receiving and transmitting seismic data from hydrophones in the seismic cable.

8. A modular seismic system according to claim 7, characterised in that it comprises:
an additional vessel equipped with an air gun and a towline, and
a transverse tow wire with a paravane fastened at each end, which is further fastened to said towlines from said vessels.

9. A modular seismic system according to claim 7, characterised in that it further comprises a plurality of streamer cables having a forward end provided with a buoy and a rear end provided with a tail buoy, and wherein at least one of the buoys comprises means for receiving and transmitting seismic data from hydrophones in the seismic cable.

10. A modular seismic system according to claim 9, characterised in that each streamer cable receives power supply either
in that it itself generates energy, this being made possible in that one or both of the buoys comprise a power generator that is driven by a rotating device which rotates owing to propulsion in the water, as well as batteries to assure regularity; or
in that it receives power supply through an electric conductor from a vessel.

11. A modular seismic system according to claim 7, characterised by comprising an asymmetric towing configuration in which one of the boats tows close to the forward buoy or buoys in order to acquire near-offset data, whilst the other tows further forward in order to acquire long-offset data.

12. A method for seismic surveying, characterised by:
positioning at least one vessel equipped with an air gun and a towline at a selected position;
attaching at least one streamer cable to said towline, the streamer cable having a forward end provided with a buoy and a rear end provided with a tail buoy, wherein at least one of the buoys further comprises means for receiving and transmitting seismic data from hydrophones in the seismic cable; and
firing the air gun and receiving seismic data via said streamer cable.

13. A method for seismic surveying according to claim 12, characterised by:
positioning an additional vessel equipped with an air gun and a towline in a selected position; and
attaching a transverse tow wire with a paravane fastened at each end, which is further fastened to said towlines from said vessels; and
firing the air guns from each vessel and receiving seismic data via said streamer cable.

14. A method for seismic surveying according to claim 13, characterised by:
attaching a plurality of said streamer cables to said tow wire; and
positioning the boats at a given distance from one another so as to obtain an asymmetric towing configuration in which one of the boats tows close to the forward buoy or buoys in order to acquire near-offset data, whilst the other tows further forward in order to acquire long-offset data.
